(19) United States
(12) Patent Application Publication
(10) Pub. No.: US 2023/0343190 A1
(43) Pub. Date: Oct. 26, 2023

(54) WIRELESS EARBUD PROXIMITY ALARM

(71) Applicant: Sony Interactive Entertainment, Tokyo (JP)

(72) Inventor: Glenn Black, San Mateo, CA (US)

(21) Appl. No.: 17/725,941

(22) Filed: Apr. 21, 2022

(51) Int. Cl. G08B 13/16; G08B 21/24

(52) U.S. Cl. CPC G08B 13/1609; G08B 21/24

(57) ABSTRACT

A motion sensor such as an accelerometer can be provided in wireless earbuds and/or the charging case for the earbuds. A wireless earbud can be placed on a table or floor and can remotely trigger an alarm if the accelerometer detects footsteps or disturbances nearby. This is useful for physical security in a hotel room or food establishment and can also generate an alert when the owner's attention is occupied in XR or is focused in a computer game.

### FIELD

The present application relates generally to wireless earbud proximity alarms.

### BACKGROUND

As recognized herein, wireless earbuds are a popular tool people use to listen to audio without wires dangling around their necks. The earbuds typically pair via Bluetooth with a portable source of audio such as a mobile phone.

### SUMMARY

As further understood herein, wireless earbuds may find dual use as proximity alarms in venues such as restaurants, cafeterias, and the like in which for example a wearer might decide to use the facilities and temporarily lay aside the earbuds by a laptop or other higher value component.

A motion sensor such as an accelerometer can be provided in wireless earbuds and/or the charging case for the earbuds. A wireless earbud can be placed on a table or floor and can remotely trigger an alarm if the accelerometer detects footsteps or disturbances nearby. This is useful for physical security in a hotel room or food establishment and can also generate an alert when the owner's attention is occupied in XR or is focused in a computer game.

Accordingly, an assembly includes left and right earbuds configured to engage the ears of a person for playing audio. A charging case is configured for charging batteries in the left and right earbuds. At least one motion sensor is supported by at least one of the earbuds or the charging case, and at least one processor programmed with instructions to receive from the motion sensor at least one signal indicating motion, and based at least in part on the signal, activate at least one alarm.

In some examples, the motion sensor is supported by at least one of the earbuds. In other examples, the motion sensor is supported by the charging case. In still other examples, the motion sensor is a first motion sensor supported by at least one of the earbuds and the assembly includes a second motion sensor supported by the charging case.

In some implementations, the alarm is activated on a device in near field communication with the earbuds or charging case. If desired, the alarm can be activated on a device not in near field communication with the earbuds or charging case.

Example embodiments include instructions executable to, based at least in part on the signal, activate the at least one alarm responsive to alarm functionality being enabled, and otherwise not activate the alarm.

In some examples the instructions can be executable to, responsive to Bluetooth signal strength between the at least one earbud having the motion sensor or charging case having the motion sensor and at least one device having a first strength, send a signal to the device via Bluetooth to activate the alarm on the device responsive to the signal indicating motion. In such an example, the device can be a first device and the instructions can be executable to, responsive to the Bluetooth signal strength having a second strength less than the first strength, switch Bluetooth pairing to a second device, send a signal to the second device via Bluetooth to activate an alarm on the second device responsive to the signal indicating motion, and send a signal to the first device to activate an alarm via a wireless link other than Bluetooth.

In another aspect, a method includes charging left and right earbuds using at least one charging case configured with first and second receptacles configured to hold the respective left and right earbuds. The method further includes providing a motion signal using at least one of the left or right earbuds or charging case for generating an alarm.

In another aspect, an apparatus includes at least one earbud configured to be located in a person's ear to provide audio into the ear. The apparatus also includes at least one charging case configured to charge at least one battery in the earbud, and at least one motion sensor coupled to the earbud or charging case to generate a signal indicating motion. Further, the apparatus includes at least one Bluetooth transceiver configured to send, based on the signal indicating motion, a motion signal to a device for activating an alarm.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates example earbuds next to an earbud charging case consistent with present principles;

FIG. 3 is a block diagram of an example earbud, charging case, and mobile device consistent with present principles;

FIG. 4 illustrates example logic in example flow chart format consistent with present principles for enabling alarm functionality for an earbud or its charging case; and

FIG. 5 illustrates example logic in example flow chart format consistent with present principles for pairing swap during alarm enablement; and

FIGS. 6 and 7 are example screen shots of example user interfaces that may be presented on any display disclosed herein consistent with present principles.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

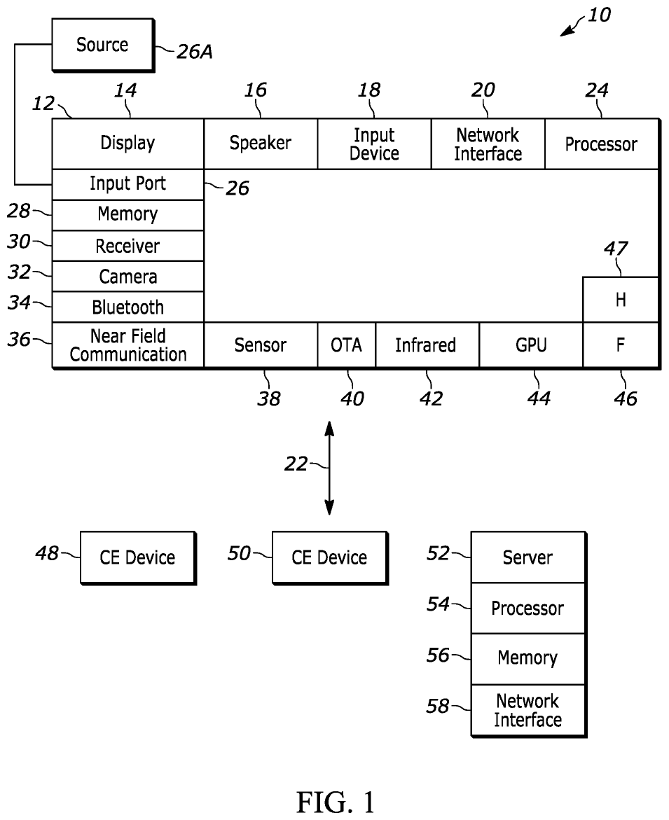

Referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage mediums 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24. The component 30 may also be implemented by an inertial measurement unit (IMU) that typically includes a combination of motion sensors such as accelerometers, gyroscopes, and magnetometers to determine the location and orientation of the AVD 12 in three dimension or by an event-based sensors.

Continuing the description of the AVD 12, in some embodiments the AVD 12 may include one or more cameras 32 that may be a thermal imaging camera, a digital camera such as a webcam, an event-based sensor, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 (e.g., a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command)) that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content.

In the example shown, only two CE devices are shown, it being understood that fewer or greater devices may be used. A device herein may implement some or all of the components shown for the AVD 12 and/or CE devices. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

For example, the earbuds and charging case may implement some or all of the components shown for the CE devices in FIG. 1 and can include those specifically shown in the figures about to be described.

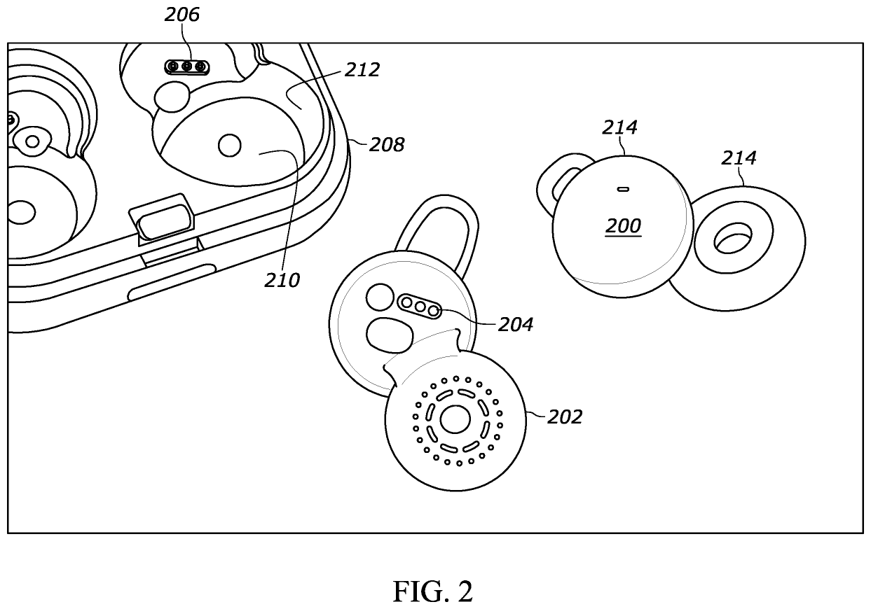

FIG. 2 illustrates left and right earbuds 200 that can receive wireless signals from a source of audio and transform the signals into sound that a person wearing the earbuds can hear. In the example shown, the earbuds 200 are shaped to fit into a respective ear of a person and hence have gently curved external surfaces 202 configured for this purpose.

As shown, each earbud 200 includes at least one and in the example shown three electric al contacts 204 for engaging respective charge contacts 206 of a charging case 208. The charge contacts 206 register with and contact the earbud contacts 204 to charge a battery in the respective earbud when the earbud is disposed in a charge receptacle 210 of the charging case 208. The charge receptacle 210 has a periphery 212 that, as can be appreciated in reference to FIG. 2, matches the outer periphery 214 of an earbud 200 so that the earbud 200 fits snugly within the receptacle 210 while charging.

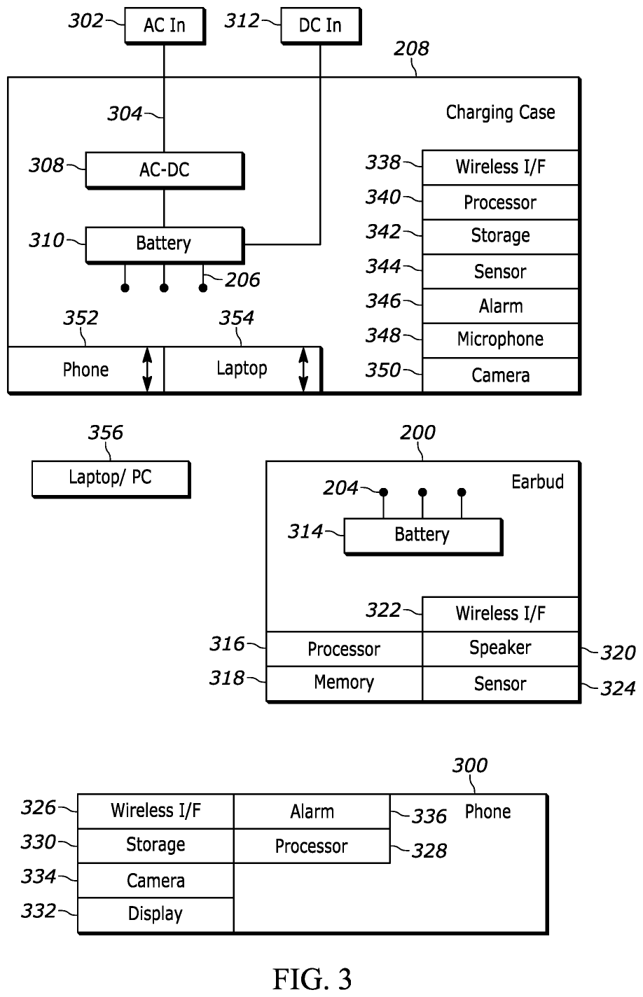

FIG. 3 illustrates example components in the earbud 200 and charging case 208, as well as in an audio source such as a mobile device 300. A source 302 of alternating current (AC) power such as an electrical socket can be engaged via cord 304 with an AC-to-DC converter 306 in the charging case 208. Output of the converter 308 may be used to charge one or more batteries 310 in the charging case in the example non-limiting architecture shown. Also, if desired, a source 312 of direct current (DC) power can be engaged with the charging case 208 to charge the battery 310. In the example architecture shown, the charge contacts 206 are electrically connected to battery 310 to provide DC power through the earbud contacts 204 when the earbud is disposed in the receptacle 210 of the charging case 208 to charge one or more batteries 314 in the earbud 200. It is to be understood that the charging case battery 310 may be omitted and the charging case contacts 206 connected directly to the DC source 312 and/or AC-DC converter 308.

The one or more batteries 314 of the earbud 200 supplies power to one or more processors 316 accessing one or more disk-based or solid-state computer storages 318 in the earbud to play audio on one or more speakers 320 within the earbud 200. The audio may be received via wireless signals through one or more wireless interfaces 322 such as one or more transceivers such as a Bluetooth transceiver and/or Wi-Fi transceiver from a source of audio such as the mobile device 300, which may be configured as a wireless phone. The earbud 200 also may include one or more sensors 324 such as motion sensors for purposes to be shortly disclosed.

The mobile device 300 may include one or more wireless interfaces 326 such as one or more transceivers such as a Bluetooth transceiver and/or Wi-Fi transceiver to communicate with the earbud 200. The mobile device 300 also may include one or more processors 328 accessing one or more disk-based or solid-state computer storages 330 that can contain audio tracks. The mobile device 300 may include one or more displays 332, one or more cameras 334, and one or more audible and/or visual and/or tactile alarms 336 that are controlled by the processor 328.

In the example shown, in addition to the charging components discussed above, the charging case 208 may include one or more wireless interfaces 338 such as a Bluetooth and/or Wi-Fi transceiver controlled by one or more processors 340 accessing one or more disk-based or solid-state computer storages 342. The processor 340 also may communicate with one or more sensors 344 such as motion sensors, one or more audible and/or visual and/or tactile alarms 346, one or more microphones 348, and one or more imagers 350 such as a still or video camera. The charging case 208 may further bear human-manipulable phone and computer selectors 352, 354 for increasing and decreasing the mix of audio played by the earbuds 200 from the mobile device 300 and from a laptop or laptop/PC 356, respectively, which may communicate with any or all of the components shown in FIG. 3. Note that while FIG. 3 illustrates hardware-implemented phone and computer selectors 352, 354, the selectors may be implemented in software using, e.g., a touch sensitive display.

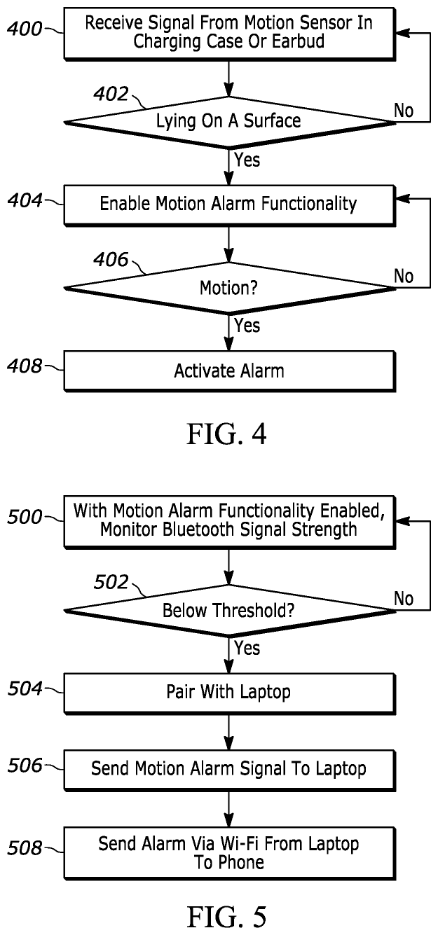

FIG. 4 illustrates logic that can be executed by any of the processors herein alone or in conjunction with other processors.

At block 400, a motion signal may be received from one or both of the motion sensors in the earbud 200 and charging case 208. Decision diamond 402 indicates that if the motion signal indicates that its respective component is lying on a surface, e.g., by registering no motion for a threshold period of time, the logic may move to block 404 to enable motion alarm functionality. For example, the processor 316 of the earbud 200 may determine whether to enable motion alarm functionality on the earbud based on signals from the motion sensor 324 of the earbud. Or, motion signals from the motion sensor 324 of the earbud 200 may be sent via Bluetooth to the phone 300, the processor 328 of which may make the determination at decision diamond 402 to enable alarm functionality at block 404.

As another example, the processor 340 of the charging case 208 may determine whether to enable motion alarm functionality on the earbud based on signals from the motion sensor 344 of the charging case 208. Or, motion signals from the motion sensor 344 of the charging case 208 may be sent via Bluetooth to the phone 300, the processor 328 of which may make the determination at decision diamond 402 to enable alarm functionality at block 404.

When motion alarm functionality is enabled, decision diamond 406 indicates that motion of the relevant component(s) (earbud, charging case) is monitored and if the signals indicate motion satisfying a threshold, such as signals that are generated when the component is moved or vibrated by nearby motion on or near the surface on which the component rests, an alarm is activated at block 408.

In one example, the processor 316 of the earbud 200 monitors for motion signals from the motion sensor 324 of the earbud, and when motion is detected, sends a signal to the phone 300 via Bluetooth to activate the alarm 336 of the phone 300. In addition, or alternatively, the processor 316 of the earbud 200 monitors for motion signals from the motion sensor 324 of the earbud, and when motion is detected, sends a signal to the laptop 356 via Wi-Fi to activate an audible or visible or tactile alarm on the laptop. Yet again, upon detecting motion the processor 316 of the earbud 200 may first send an alarm signal to the phone 300 via Bluetooth, then automatically swap Bluetooth pairing to the laptop, with which the earbud can be pre-registered to pair with, and send an alarm signal to the laptop.

In other examples motion signals are sent from the earbud 200 and/or charging case 208 to the phone 300 and/or laptop 356 for the processors of the device(s) receiving the signals to execute the motion determination at decision diamond 406.

When motion alarm functionality is enabled, FIG. 5 illustrates an optional function in which Bluetooth signal strength or other indication of communication link existence is monitored at block 500. For example, when alarm functionality of an earbud 200 is enabled and the earbud is paired with the phone 300, the processor 328 of the phone 300 monitors for signal strength from the earbud 200. Or, the processor 316 of the earbud 200 may monitor for signal strength in the Bluetooth link from the phone 300. Note that the same logic may apply for the case in which the earbud or charging case is paired with the laptop 356, in which case the signal strength of the link between the earbud/charging case and laptop is monitored.

Yet again, when alarm functionality of the charging case 208 is enabled and the charging case is paired with the phone 300, the processor 328 of the phone 300 monitors for signal strength from the charging case 208. Or, the processor 340 of the charging case 208 may monitor for signal strength in the Bluetooth link from the phone 300.

Decision diamond 502 indicates that when Bluetooth signal strength falls below a threshold, the logic may move to block 504 to automatically switch Bluetooth pairing of the earbud 200 (and/or charging case 208) from the phone 300 to the laptop 356. It is to be appreciated that when initial pairing is with the laptop, at block 504 Bluetooth pairing is switched from the laptop to the phone. Any subsequent motion alarms signals are sent at block 506 to the component pairing was switched to at block 504.

Moreover, at block 508 the device receiving the motion alarm signal at block 506 can send, e.g., via Wi-Fi or other link (such as a wireless telephony link), the alarm signal to the device from whence pairing was switched away from at block 504.

It may now be appreciated that a person working on a laptop 356 while enjoying music on earbuds 200 from a phone 300 in a restaurant or other location may briefly remove the earbuds, lay them next to the laptop, and visit the facilities with phone in pocket. Should the laptop or earbud/charging case be moved in the owner's absence, the owner will receive notification by way of the alarm on the phone 300, either through the original Bluetooth link with the earbud/charging case or, if that link weakened, through Wi-Fi or other avenue from the laptop according to FIG. 5.

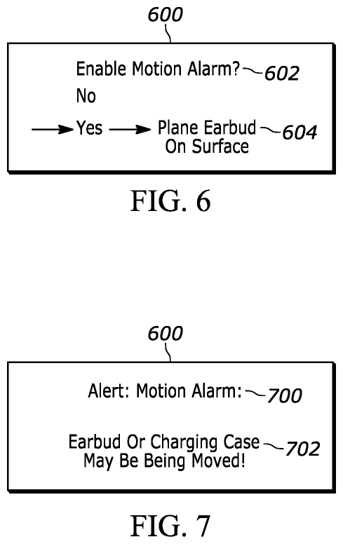

FIGS. 6 and 7 illustrate user interfaces (UI) that may be presented on any display 600 disclosed herein, such as the display 332 of the phone 300 or the display of the laptop 356. A prompt 602 may be presented to the user whether to enable the motion alarm functionality discussed above. The user may select not to enable the functionality (equivalently, to turn off the functionality when, for instance, the user decides to once again place the earbuds in his ear for listening to audio). The user may also select, at 604, to enable the alarm functionality, in which case a prompt may be presented as shown to place the earbuds (or charging case) on a surface.

FIG. 7 illustrates at 700 a non-limiting example of a visible alarm that motion has occurred while in the alarm functionality mode. An advisory 702 may be presented specifying that the earbud or charging case or laptop may be in the process of moving. In addition, or alternatively, other visible alarms such as blinking light emitting devices on the phone 300 and/or laptop 356 may be activated in response to a motion signal from the earbuds and/or charging case. Yet again, audible alarms may be emitted from any of the device herein, as well as haptic-based tactile alarms.

Note that when both the charging case 208 and earbuds 200 are equipped with motion sensors for present purposes, in one implementation a motion signal from only one is needed to trigger an alarm. In other implementations motion signals must be received from both an earbud and the charging case to trigger an alarm, to reduce the chance of false alarms.

While the particular embodiments are herein shown and described in detail, it is to be understood that the subject matter which is encompassed by the present invention is limited only by the claims.

1. An assembly, comprising:
left and right earbuds configured to engage the ears of a person for playing audio; and
a charging case configured for charging batteries in the left and right earbuds;
at least one motion sensor supported by at least one of the earbuds or the charging case; and
at least one processor programmed with instructions to:
receive from the motion sensor at least one signal indicating footsteps or vibrations; and
based at least in part on the signal, activate at least one alarm.

2. The assembly of claim 1, wherein the motion sensor is supported by at least one of the earbuds.

3. The assembly of claim 1, wherein the motion sensor is supported by the charging case.

4. The assembly of claim 1, wherein the motion sensor is a first motion sensor supported by at least one of the earbuds and the assembly comprises a second motion sensor supported by the charging case.

5. The assembly of claim 1, wherein the alarm is activated on a device in near field communication with the earbuds or charging case.

6. The assembly of claim 1, wherein the alarm is activated on a device not in near field communication with the earbuds or charging case.

7. The assembly of claim 1, wherein the instructions are executable to:
activate the at least one alarm responsive to motion alarm functionality being enabled by input to at least one user interface presented on at least one computing device.

8. The assembly of claim 1, wherein the instructions are executable to:
responsive to Bluetooth signal strength between the at least one earbud having the motion sensor or charging case having the motion sensor and at least one device having a first strength, send a signal to the device via Bluetooth to activate the alarm on the device responsive to the signal indicating motion.

9. The assembly of claim 8, wherein the device is a first device and the instructions are executable to:
responsive to the Bluetooth signal strength having a second strength less than the first strength, switch Bluetooth pairing to a second device, send a signal to the second device via Bluetooth to activate an alarm on the second device responsive to the signal indicating motion, and send a signal to the first device to activate an alarm via a wireless link other than Bluetooth.

10. The assembly of claim 1, wherein the charging case is configured with first and second receptacles configured to closely hold the respective left and right earbuds.

11. A method, comprising:
receiving from at least one earbud and/or at least one charging case configured to charge at least one battery in the earbud at least a first signal indicating no motion for at least a period of time;
responsive to the first signal, enable motion alarm functionality;
responsive to motion alarm functionality being enabled, providing a motion signal using at least one of the left or right earbuds or charging case for generating an alarm, wherein the alarm is not generated responsive to motion alarm functionality not being enabled regardless of motion of the earbud and/or charging case.

12. The method of claim 11, comprising providing a motion signal using at least one of the left or right earbuds.

13. The method of claim 11, comprising providing a motion signal using the charging case.

14. The method of claim 11, comprising sending the motion signal to a device over near field communication from at least one the earbuds or charging case.

15. The method of claim 11, comprising sending the motion signal to a device on a link other than near field communication from at least one the earbuds or charging case.

16. The method of claim 11, comprising:
based at least in part on the signal, activating the at least one alarm responsive to alarm functionality being enabled, and otherwise not activating the alarm.

17. The method of claim 11, comprising:
responsive to Bluetooth signal strength between at least one earbud or charging case having a first strength, sending a signal to a device via Bluetooth to activate the alarm on the device responsive to the motion signal.

18. The method of claim 11, wherein the device is a first device and the method comprises:
responsive to the Bluetooth signal strength having a second strength less than the first strength, switching Bluetooth pairing to a second device, sending a signal to the second device via Bluetooth to activate an alarm on the second device responsive to the motion signal, and sending a signal to the first device to activate an alarm via a wireless link other than Bluetooth.

19. An apparatus comprising:
at least one earbud configured to be located in a person's ear to provide audio into the ear;
at least one charging case configured to charge at least one battery in the earbud;
at least one motion sensor coupled to the earbud or charging case to generate a signal indicating motion; and
at least one transceiver on the earbud or charging case configured to send to a wireless telephone, based on the signal indicating motion, a motion signal for activating an alarm on the wireless telephone such that a person may remove the earbud from the person, lay it on a surface, and move to another location with the wireless telephone, and should the earbud and/or charging case be moved in the person's absence, the person receives notification by way of the alarm on the wireless telephone phone, either through a Bluetooth link or, if the Bluetooth link is weakened, through Wi-Fi.

20. The apparatus of claim 19, comprising the device, the device being configured to activate the alarm responsive to receiving the motion signal.
